(19) United States
(12) Patent Application Publication
(10) Pub. No.: US 2009/0020598 A1
(43) Pub. Date: Jan. 22, 2009

(54) Post Office Box and Post Office Box System

(76) Inventors: Antoine Mercier, Montmorency (FR); Florence Hirel, Chatillon (FR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/913,930

(22) PCT Filed: May 5, 2006
(86) PCT No.: PCT/FR2006/001013

§ 371 Date: Mar. 26, 2008

(30) Foreign Application Priority Data
May 9, 2005 (FR) 0504627

(51) Int. Cl. A47G 29/122; A47G 29/12; G08B 21/18

(52) U.S. Cl. 232/36; 232/43.1; 340/686.4

(57) ABSTRACT

A post office box (2) including an enclosed space (3) defined by a front surface (7) with an opening (20) fitted with a sealing device (21) that includes a first sealing element (31) movable between an open position in which the space is accessible via the front opening, and a closed position in which the front opening (20) is substantially sealed, and which includes a locking device (50) for locking the first sealing element (31). The box (2) comprises a locking element (41) movable along a rear surface (8) and connected to the first sealing element (31) via a connection (49) for transmitting a movement proportional to the movement of the first sealing element (31), said locking device (50) being mounted on the rear surface (8) and engageable with the locking element (41). A post office box system (1) including a plurality of such boxes is also disclosed.

This invention relates to a post office box and a post office box system made up of a collection of post office boxes constructed in accordance with the invention.

More particularly, the post office box comprises an enclosure bounded by a front face, a rear face, and side faces joining the front and rear faces,
the front face having an opening fitted with a closure device comprising at least one first closure element that can be moved between an open position in which the interior of the enclosure is accessible through the front opening, and a closed position in which the front opening is able to be closed by the closure device, and
the rear face having a rear opening, and
comprising a fastening device able to keep the first closure element in the closed position.

Post office boxes of this kind are known, especially in post offices. They are usually arranged to form columns of adjacent post office boxes mounted through a wall which separates a space accessible to the public from a space reserved to post office staff. All the rear openings are on the side reserved for personnel, allowing personnel to place mail in the enclosure of the post office box through this rear opening, which generally has no closure system. The front openings of the post office boxes are on the side accessible to the public and are closed by a door fitted with a key-operated lock, so that only the owner of a given post office box can collect the mail it contains.

Such a door fastening device, usually a flat key-operated lock mounted through the door, can quite easily be forced or broken. To date, however, public access to post office boxes has usually only been possible during post office opening hours so that postal workers can keep a visual check on the post office boxes. It is therefore uncommon for post office boxes to be broken into to steal the mail or parcels from them. But users are now asking to be able to access their post office boxes during longer periods, potentially 24 hours a day, 7 days a week. For such purposes, the security of existing post office box systems is inadequate.

It is therefore an object of this invention to improve on existing post office box systems, notably as regards resistance to break-ins of the publicly accessible closure devices, but without excessively increasing the cost of the boxes of which the system is composed.

For this purpose, the subject of the present invention is a post office box of the type set out above, characterized in that a securing element mounted movably close to the rear face is connected to the first closure element by a connection designed to transmit to the securing element a movement proportional to the movement of the first closure element, and in that the fastening device is mounted close to the rear face and comprises an electrically controlled movable member designed to engage with the securing element when the first closure element is in the closed position.

With these arrangements, the fastening device and the securing element are situated on the side reserved for authorized personnel, to which an ill-intentioned person would not normally have access. As a result, the fastening device, which is very often the most sensitive part of the closure device, is all but impossible to get at for the purposes of breaking in directly from the public side. The fastening device can therefore be made simpler, with no elaborate reinforcement against breakage, which can reduce its cost. Also, the fastening device does not need protecting with armored protection and is therefore more accessible in the event of maintenance work.

The movable member forming the bolt of the fastening device, and the part forming the strike of the securing element with which the bolt can be made to engage, especially by inserting the bolt into the strike when the securing element is in the closed position, are designed to form a sufficiently sturdy lock to withstand an attempted break-in involving forcing the first closure element out of position. If the first closure element is fitted with a handle, the handle is preferably designed to break or detach above a certain abnormal force threshold applied to it, and the limit of resistance of the fastener on the rear of the post office box is then designed to be greater than this force threshold. Whether or not the first closure element is fitted with a handle, as for example in the case of a rolling shutter moved by a motor designed to drive the securing element, the fastener formed by the movable member engaging with the securing element is designed to withstand to some extent an attempt to move the rolling shutter. In particular, the case of an ill-intentioned person piercing or breaking a slat in order to obliquely strike this slat or strike a slat reinforcing element and so displace the shutter sideways must be considered. In a break-in of this kind, the fastener on the rear of the box is sturdy enough to withstand the forces of the blows delivered to the slat which are transferred to the securing element after being to some extent damped out by the connecting member.

It will be observed that the use of an electrically controlled movable member means that it is possible to relocate and bring together the control of the opening of the post office boxes in a user identification terminal common to all of the post office boxes. This may for example recognize a personal identification code and/or read a smart card.

Various preferred embodiments of the invention also make use of one or other of the following arrangements:
the fastening device comprises an electromechanical actuator mounted on the rear face outside of the enclosure, thus not reducing the amount of space available inside the enclosure, limiting the range of possible illicit activities on it when the front opening is opened, and facilitating its maintenance;
the first closure element is a first curtain that can be moved along at least one track comprising a portion running along the front face and a portion in the shape of an arc of a circle oriented toward the rear face, and the securing element is a second curtain that can be moved along at least one other track comprising a portion that runs along the rear face and a portion in the shape of an arc of a circle oriented toward the front face, said first and second curtains being connected by a rigid distance piece, thus making it possible to produce fastening and securing elements that can be moved in different directions, yet limit the number of parts needed to create these elements;
the closure device comprises a second element in the form of a pivoting door that has a slot running down one of its lateral sides, in which slot the first closure element can be engaged when it is in the closed position, so the additional cost of making a hinged first closure element to transmit its movement toward the rear face, is kept strictly to a minimum;
an antifastening device having a stop element that can be moved between an inactive position in which the path of the first closure element toward the closed position is unobstructed, and an antifastening position in which it is elastically returned and in which it extends into said path in order to stop the first closure element moving into its closed position, the second closure element being able to interact with the antifastening device in such a way as to position the stop element in the inactive position when said second closure element is in the closed position, so that the first closure element cannot be fastened in the closed position unless the whole of the closure device is in the closed position;
the stop element is an arm extending along the track of the first closure element in the portion occupied by said element in the closed position, and which is elastically returned to the antifastening position by an elastic connection with a fixed arm fixed against a wall of said track, the second closure element comprising a stud for interacting and moving the stop element from the antifastening position to the inactive position when said second closure element is being closed;
the rear opening of the enclosure is fitted with a shutter that can be moved between a position in which the enclosure is accessible through the rear opening and a closed position in which the rear opening is closed off, a position sensor designed to emit a signal when the rear shutter is in the closed position being provided, such that the post office box is suitable for delivering a signal to a control system indicating that a parcel or item of mail has been left by a post office employee;
the sensor is also designed to deliver a signal when the securing element is in a position corresponding to the closed position of the first element of the closure device;
the sensor comprises a probe that has a pivoting pin through which a rigid arm slides, and two spring legs extending on either side of the arm from the pin and able to make contact with the securing element of the first fastening element and with the rear shutter, respectively, so that the arm of the probe occupies a specified position when the first closure element and the rear shutter are both in the closed position.

The present invention also relates to a post office box system comprising a plurality of post office boxes as defined above, the fastening devices of said post office boxes being connected to a common electronic control terminal.

For specific embodiments of the post office box system, any of the following arrangements may be employed:
at least some of the post office boxes are arranged to form two adjacent columns, the fastening devices being situated on the outside of the rear face of each of said boxes and in the vicinity of the vertical lateral side adjacent to another box, so that the fastening devices can be contained inside a protective duct common to the two columns; and
the common control terminal is designed to send users information indicating that an object has been left in one of the post office boxes of the system, on the basis of signals delivered by the position sensor of the rear shutter.

Other features and advantages of the invention will become apparent in the course of the following description, which is given by way of nonrestrictive example with reference to the attached figures, in which:

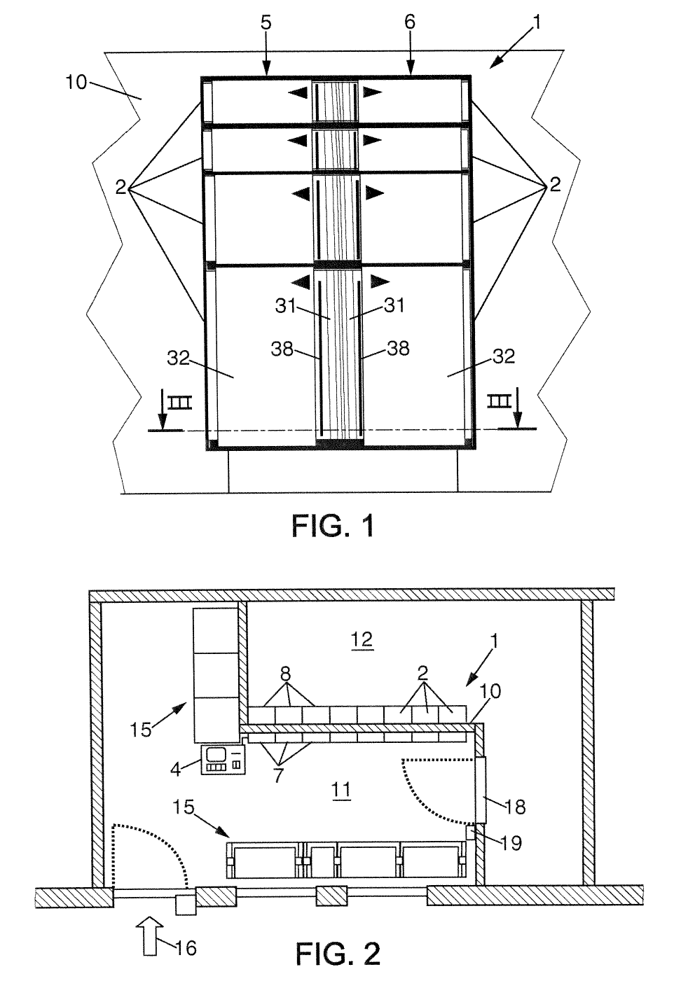

FIG. 1 is a front view of a post office box system comprising post office boxes according to the invention;

FIG. 2 is a partial plan of a building comprising the post office box system shown in FIG. 1;

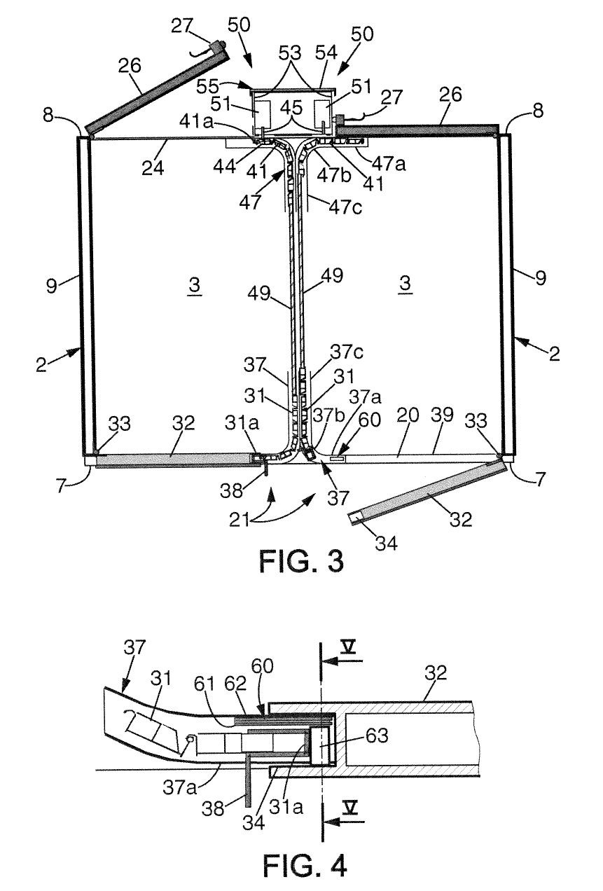

FIG. 3 is an enlarged horizontal schematic cross section on III-III as marked in FIG. 1 through a pair of post office boxes;

FIG. 4 is an enlarged partial view from FIG. 3 with a closure device in the closed position;

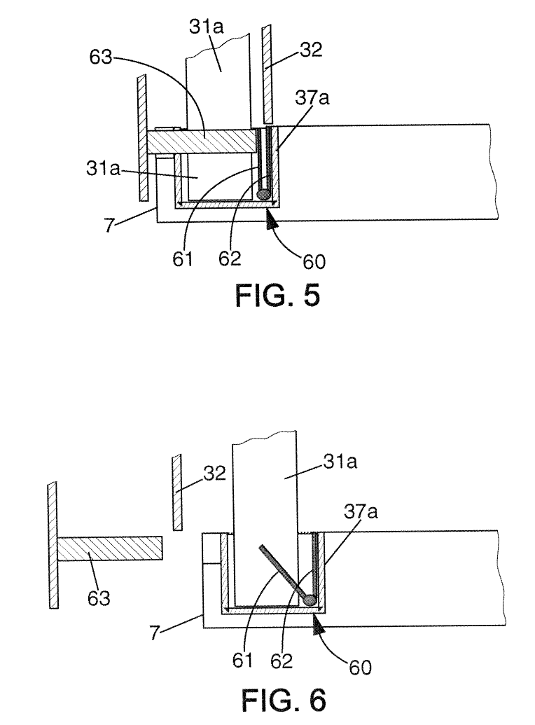

FIG. 5 is a vertical cross section on V-V in FIG. 4;

FIG. 6 is a view similar to FIG. 5 in which the closure device is in the open position;

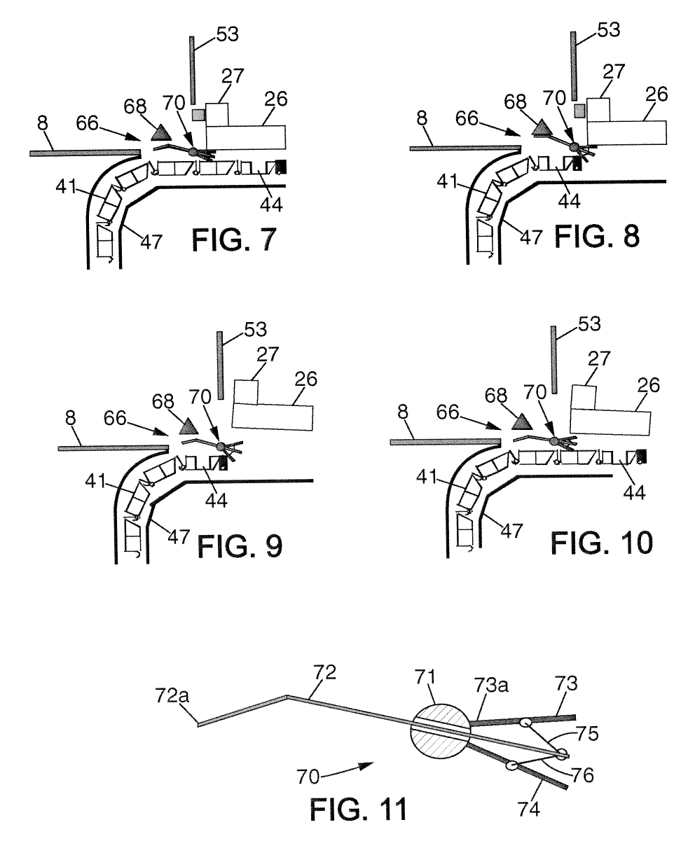

FIGS. 7 to 10 are partial schematic views in horizontal cross section in which the closure elements and a probe are in various different positions; and

FIG. 11 is an enlarged schematic view of the probe shown in FIGS. 7-10.

Throughout the figures, identical reference numbers are used to denote identical or similar elements.

FIG. 1 shows a system of post office boxes 1, visible from the front, that is to say from the side from which users come to take mail from their post office box. The system 1 comprises a plurality of post office boxes 2 arranged relative to each other in such a way as to form a first column 5 and a second column 6. The post office boxes 2 are identical in width and depth so that they form regular columns, but may be different in height so as to offer variable capacities. However, for reasons which will become apparent later, it is preferable that all the boxes 2 in a given horizontal row are of the same height.

Each box 2 has a front face 7, a rear face 8 and four side faces 9, visible in FIG. 3, joining the front and rear faces together. The front face 7, rear face 8 and side faces 9 define an enclosure 3 in which mail or parcels can be left.

As can be seen in FIG. 2, the boxes 2 are set through a wall 10 that separates a space accessible to the public 11 from a reserved space 12 accessible only to authorized personnel, such as postal workers or any other mail or parcel distribution company. The front faces 7 of the boxes are situated on the public side 11 while the rear faces 8 are situated on the side 12 reserved for authorized personnel.

The room also comprises in the public space 11 a computer terminal 4 connected to the post office box system 1: this is for controlling the post office boxes 2, notably by identifying users and unlocking the boxes.

The plan shown in FIG. 2 represents a room for the collection of mail using the post office box system 1, and for leaving parcels using a delivery system 15 installed in the public space 11, rather than a full-scale post office, because no counters are provided. The public space 11 is freely accessible through the entrance indicated by the arrow 16, which is preferably open 24 hours a day, 7 days a week. The space reserved for authorized personnel 12 is accessible through an inner door 18 which can only be opened after a person has identified himself or herself through the access control device 19, which may be of any known type.

As can be seen in FIG. 2, each box 2 has an opening 20 that passes through the front face 7 and can be closed by a closure device 21.

The closure device 21 can adopt a closed position, shown on the left-hand post office box 2 in FIG. 3, or an open position, shown on the right-hand post office box in FIG. 3, thereby either allowing or denying access to the contents of the enclosure 3 through the front opening 20.

The rear face 8 of each post office box also has an opening 24, to allow authorized personnel to easily put mail or parcels in the enclosure 3 of the post office boxes 2.

In the embodiment illustrated, the rear face 8 comprises a shutter 26 which can be moved between an open position, in which the enclosure 3 is accessible through the opening 24, and a closed position, in which the shutter 26 blocks the rear opening 24 so that, in this embodiment, the boxes 2 form safes. However, the presence of such a shutter is not indispensable since the rear opening 24 is only accessible by the authorized personnel. Furthermore, the pivoting shutter 26 which could also be made in the form of a rolling shutter is held in the closed position by no more than a simple pull catch 27. Authorized personnel do not therefore need to use a key or follow an identification procedure to open the rear shutter 26, and mail and parcels can be left quickly.

The fastening device 21 comprises a first closure element 31 formed, in the embodiment illustrated, by a curtain consisting of slats hinged together. The slats of the curtain 31 are arranged vertically and may be made of metal or plastic, optionally with a reinforcing element inserted in the profile.

The closure device 21 also comprises a second closure element 32 formed by a shutter pivoting about a vertical pin 33. The shutter 32 is preferably made of sheet metal and has a slot 34 extending vertically down the lateral side opposite the hinge pin 33.

The curtain 31 slides in a first track 37, visible in FIG. 3, which runs horizontally along the lower side face of the enclosure 3. A second track, not visible in the figures, but similar to the first, is provided along the upper side face of the enclosure 3. The curtain 31 is thus securely guided.

The track 37 has an essentially straight portion 37a extending for a short distance along the front face 7, followed by a portion in the form of an arc of a circle 37b, in turn continued by a straight portion 37c extending toward the rear face 8.

As can be seen on the left-hand side of FIG. 3, the curtain 31 has a free end 31a which is engaged in the slot 34 of the door 32 when these two closure elements of the closure device 21 are both in the closed position. Engaging the free end 31a, which is immobilized in the direction of the front opening 20 by the track 37, in the slot 34 prevents the door 32 being swung open to the position shown on the right.

To open the closure device 21, the curtain 31 must be free to slide along the track 37. The user can then take hold of a handle 38 attached to the curtain 31 to push its free end 31a toward the portion in the shape of an arc of a circle 37b of the track and reach the open position shown on the right-hand side of FIG. 3. The door 32 is then free to pivot to a more or less wide-open position, for example by grasping the side edge in which the slot 34 is formed. It would be observed that in the embodiment illustrated, it is essentially the inner flange of the slot 34 which prevents the door 32 being opened. Pushing the door 32 further in than the closed position can be prevented by the outer flange of the slot 34, but also by a step 39 formed in the frame defining the perimeter of the front opening 20.

As can be seen in FIG. 3, each post office box 2 has a second articulated curtain 41 sliding in a corresponding first track 47 extending in the plane of the lower side face, and a second or upper track of identical form, not visible in the figures. In a similar way to track 37, track 47 has a portion 47a extending along the rear face 8, a portion in the shape of an arc of a circle 47b that orients the track toward the front face 7, and a straight portion 47c aligned with the portion 37c of the track of the first closure element 31.

The rear curtain 41 is connected to the curtain 31 forming the front face 7 closure element by a rigid distance piece 49 which in the embodiment illustrated takes the form of a rigid metal frame whose opposite ends are connected, one to the first slat of curtain 31, and the other to the first slat of curtain 41. Consequently, the movement of the rear curtain 41 is proportional to the movement of the front curtain 31, or in other words neither of the two curtains 31 or 41 can be moved without moving the other curtain. Owing to the rigidity of the distance piece 49 and to the structure of the curtains, the movements are of exactly the same amplitude, though it is perfectly conceivable for the curtains to be connected by a mechanism that amplifies or reduces the movement of one curtain compared with the other.

The rear curtain 41 has a housing 44 close to its free end 41a, in other words in that portion which extends along the rear face 8 when the curtain 31 forming the first closure element is in the closed position. A bolt 45 situated close to the rear face 8 is movable between an inactive position, shown on the right-hand side of FIG. 3, and a locked position in which it is engaged with the housing 44 which forms a strike in the articulated curtain 41, as can be seen on the left-hand side. The curtain 41 therefore forms a securing element, immobilization of which in the position shown on the left-hand side in FIG. 3 has the effect of locking the first closure element 31 in the closed position.

The bolt 45 is part of a fastening device 50 that includes, besides the bolt, an electromechanical actuator 51 for placing the bolt in the inactive position or in the locked position in response to control signals received from the identification terminal 4 installed in the public space 11. The fastening device 50 is mounted on the outside of the rear face 8 on vertical flanges 53 projecting at right angles to this face. The bolt 45 thus performs a movement through a window in the rear face 8 in a direction perpendicular to said face and perpendicular to portion 47a of the track. By means of this arrangement, the fastening device 50 is located in the reserved space 12. The fastening device 50 is therefore very difficult to get at through the front opening 20, and the presence of the shutter 26 with its catch 27 makes such access virtually impossible. Also, the fact that the fastening device 50 of each box 2 is situated in the reserved space 12 and on the outside of the enclosure 3 facilitates their access for maintenance work.

As FIG. 3 shows, the securing elements formed by the curtains 41, and hence their respective fastening devices 50, of two post office boxes belonging to two adjacent columns (5, 6) are located against the common side face (no reference number) of these two post office boxes, in a symmetrical arrangement. The flanges 53 of the two post office boxes and a removable plate 54 extending between the free edges of these flanges, thus define a duct 55 common to the two columns (5, 6) of post office boxes, the duct containing all the fastening devices 50. Removing the single trim plate 54 gives immediate access to all the actuators 51, e.g. in order to move them if the columns are being reconstructed with post office boxes of different sizes.

In order to prevent the first closure element 31 being positioned or locked in the closed position when the second closure element formed by the door 32 is still open, an antifastening device 60 is provided. The antifastening device 60 is a V-shaped metallic spring rebate mounted inside the portion 37a of the track 37. As will be seen more clearly in FIGS. 4-6, which are enlarged views of the portion 37a of the track, the antifastening device 60 has an arm 61 extending diagonally across the track 37 when the door 32 is not in the closed position (FIG. 6), so preventing the free end 31a of the curtain 31 from reaching its closed position. A fixed arm 62 forming the second side of the V shaped rebate is fixed to the inside vertical wall of the track 37.

A stud 63 is arranged in the slot 34 of the door 32 in such a way as to contact and push back the arm 61 against the fixed arm 62 when the door 32 is pushed shut. This passage of the stud 33 through a hole or opening in the portion 37a of the track positions the antifastening device 60 in the inactive position and the curtain 31 can then be closed (FIGS. 4 and 5) using the handle 38.

Each post office box 2 is fitted with a sensor 66, represented symbolically in FIGS. 7-10, which is designed to emit a signal when the shutter 26 is in the open position. The sensor 66 may be of any known type. For example, it may be a contactor which makes direct contact with the shutter 26, or an optical cell arranged opposite a reflective target fixed to the door or to an intermediate element. The sensor 66 is advantageously placed in the duct 55 because of the latter's proximity to the shutter 26. Like the actuators 51, the sensors 66 are connected electrically, or by any other means, to the terminal 4 which controls all the post office boxes of the system 1 in common. The signal transmitted to the terminal 4 may be in any known form, such as for example a pulse of current or the making of a contact, either when the door is closed or when it is open.

The terminal 4 comprises data processing means for determining, from the incoming sequence of signals, information representing the fact that the shutter 26 has been opened and then closed again. Opening of the shutter 26 implies of course that an authorized employee is putting mail or a parcel in the enclosure 3 of a given post office box. It is then particularly advantageous for the common control system formed by the terminal 4 to be designed to notify the user of the given post office box that an object has been placed in it. This information, which may for example be sent in the form of electronic mail over the Internet, saves the post office box user coming in if no mail has been deposited in the enclosure of his post office box.

For security of operation of the fastening device 50, it is particularly useful if the terminal 4, which sends the signals to fasten and/or unfasten each of the devices 50 of the post office boxes 2, receives information enabling it to determine the actual position of the corresponding securing element 41. It is of course possible to have two separate sensors to determine the position of the shutter 26 and the position of the securing element 41. However, because of the construction of the fastener of the first closure element 31, which uses a securing element mounted movably in the vicinity of the rear face, this securing element 41 and the shutter 26 may be situated close together. It is therefore advantageous for cost reasons to use only one sensor 66 for a given post office box.

Various solutions may be envisaged for producing a signal indicating the simultaneously closed positions of the shutter 26 and of the first closure element 31. However, in a preferred embodiment, the sensor 66 comprises in addition to a detection element 68, such as a contactor or an optical cell, a probe 70 which can be seen in FIGS. 7-10.

The probe 70 is designed to adopt a given position where it comes into contact with the detector 68 when the shutter 26 and securing element 41 are both in a position corresponding to the closed position of the shutter 26 and to the closed position of the first closure element 31 respectively—in other words, the configuration shown in FIG. 8; whereas if one of these elements is not in the closed position, the probe 70 occupies a position in which the detector 68 emits no signal, as for example when the front curtain 31 is open (FIG. 7), or when the rear shutter 26 is open (FIG. 9), or indeed when both of these elements (31, 26) are open (FIG. 10).

In order to fulfill this function, the probe 70, which can be seen more clearly in FIG. 11, comprises a pivoting pin 71 in which is an opening through which a rigid arm 72 slides and two spring legs (73, 74) extend from the pin 71 on either side of the rigid arm. When one of the legs 73 is compressed toward the rigid arm 72, it exerts a torque through its base 73a on the pin 71. The pin then pivots through an angle proportional to the compression applied to the leg 73 so that the torque exerted by the leg is cancelled out by the opposing torque of the other leg 74. The rotation of the pin 71 causes a change in the orientation of the opening passing through it, and consequently a change in position of the rigid arm 72. This change of position is greater the further away the end 72a of the arm 72 is from the pin 71. By arranging the probe 70 relative to the securing element 41 and to the shutter 26 in such a way that these elements (41, 26) make contact with a corresponding arm (73, 74) at least when they are either closed or open, it is possible to obtain a specified position for the end 72a of the rigid arm 72 when both the first closure element 31 and the shutter 26 are in the closed position. This specified position of the arm 72 is detected by appropriately positioning the detector 68, which then emits a single signal to the common control terminal 4. Although this single signal corresponds to a particular position of two elements (26, 41), it is possible to determine whether it is the closure element 21 of the front opening 20 (allowing mail to be withdrawn) or the shutter 26 of the rear opening 24, that has been opened, by analyzing the sequence of signals received from the sensor 66 of a given post office box 2 and the control signals sent by the terminal 4 to the fastening device 50 of this post office box.

As can be seen in FIG. 11, hinged links (75, 76) are also provided between each of the legs (73, 74) and the rigid arm 72. These links (75, 76) form, with the legs (73, 74) and the pin 71, a deform able quadrilateral that guides the orientation of the arm 72 at two opposite angles.

Clearly, the embodiment described above is in no sense restrictive. Besides the variants already indicated, it is also possible to provide only one closure element to close the front opening 20. However, for a given area of opening, a door 32 with a sheet metal thickness may offer more resistance to break-in than an articulated curtain while being less expensive than the latter.

1. A post office box comprising an enclosure bounded by a front face, a rear face, and side faces joining said front and rear faces,
said front face having a front opening fitted with a closure device comprising at least one first closure element that can be moved between an open position in which the interior of said enclosure is accessible through said front opening, and a closed position in which said front opening is able to be closed by said closure device; and
said rear face having a rear opening and
comprising a fastening device able to keep said first closure element in said closed position;
wherein a securing element mounted movably close to said rear face is connected to said first closure element by a connection designed to transmit to said securing element a movement proportional to the movement of said first closure element;
and wherein said fastening device is mounted close to said rear face and comprises an electrically controlled movable member designed to engage with said securing element when said first closure element is in said closed position.

2. The post office box as claimed in claim 1, in which said fastening device comprises an electromechanical actuator mounted on said rear face outside of said enclosure.

3. The post office box as claimed in claim 1, in which said first closure element is a first curtain that can be moved along at least one track comprising a portion running along said front face and a portion in the shape of an arc of a circle oriented toward said rear face, and in which said securing element is a second curtain that can be moved along at least one other track comprising a portion that runs along said rear face and a portion in the shape of an arc of a circle oriented toward said front face, said first and second curtains being connected by a rigid distance piece.

4. The post office box as claimed in claim 1, in which said closure device comprises a second element in the form of a pivoting door that has a slot running down one of its lateral sides, in which slot said first closure element can be engaged when it is in said closed position.

5. The post office box as claimed in claim 4, in which an antifastening device having a stop element that can be moved between an inactive position in which the path of said first closure element toward said closed position is unobstructed, and an antifastening position in which it is elastically returned and in which it extends into said path in order to stop said first closure element moving into its closed position, said second closure element being able to interact with said antifastening device in such a way as to position said stop element in said inactive position when said second closure element is in said closed position.

6. The post office box as claimed in claim 5, in which said stop element is an arm extending along the track of said first closure element in the portion occupied by said first closure element in said closed position, and which is elastically returned to said antifastening position by an elastic connection with a fixed arm fixed against a wall of said track said second closure element comprising a stud for interacting and moving said stop element from said antifastening position to said inactive position when said second closure element is being closed.

7. The post office box as claimed in claim 1, in which said rear opening of the enclosure is fitted with a rear shutter that can be moved between a position in which said enclosure is accessible through said rear opening and a closed position in which said rear opening is closed off, and in which a position sensor designed to emit a signal when said rear shutter (26) is in said closed position is provided.

8. The post office box as claimed in claim 7, in which said sensor is also designed to deliver a signal when said securing element (41) is in a position corresponding to said closed position of said first element of the closure device.

9. The post office box as claimed in claim 7, in which said sensor comprises a probe that has a pivoting pin through which a rigid arm slides, and two spring legs extending on either side of said rigid arm from said pin and able to make contact with said securing element of the first fastening element and with said rear shutter, respectively, so that said arm occupies a specified position when said first closure element and said rear shutter are both in said closed position.

10. A post office box system comprising a plurality of post office boxes as claimed in claim 1, characterized in that said fastening devices of the post office boxes are connected to a common electronic control terminal.

11. The post office box system as claimed in claim 10, in which at least some of the post office boxes are arranged to form two adjacent columns, said fastening devices being situated on the outside of said rear face of each of said boxes and in the vicinity of the vertical lateral side adjacent to another box.

12. The post office box system as claimed in claim 10, in which the common control terminal is designed to send users information indicating that an object has been left in one of the post office boxes of the system, on the basis of signals delivered by the position sensor of the rear shutter.
